(19) United States
(12) Patent Application Publication
(10) Pub. No.: US 2021/0080605 A1
(43) Pub. Date: Mar. 18, 2021

(54) Methods for the Regional-Scale Simulation of Hydraulic Fracturing

(71) Applicant: W. D. Von Gonten Laboratories, LLC, Houston, TX (US)

(72) Inventors: Egor Dontsov, Houston, TX (US); Roberto Suarez-Rivera, Houston, TX (US)

(21) Appl. No.: 17/023,682

(22) Filed: Sep. 17, 2020

Related U.S. Application Data
(60) Provisional application No. 62/901,446, filed on Sep. 17, 2019.

(51) Int. Cl. G01V 1/28; G01V 1/30; G01V 11/00; G01V 99/00

(52) U.S. Cl. CPC G01V 1/282; G01V 99/005; G01V 11/002; G01V 1/301

(57) ABSTRACT

Methods for constructing a regional-scale geomodel by obtaining high-resolution stratigraphic data at a plurality of locations within an area of interest. A regional-scale resolution can be selected based on one or more identified structural features at the plurality of locations and the high-resolution stratigraphic data homogenized to the regional-scale resolution so as to generate regional-scale stratigraphic data. This homogenization is performed using a technique that preserves energy consumption during fracture propagation. The regional-scale stratigraphic data is then interpolated between the plurality of locations so as to create a regional-scale geomodel in the area of interest that can be used to perform numerical simulations of hydraulic fracturing using the regional-scale geomodel.

### CROSS-REFERENCE TO RELATED APPLICATIONS

This application claims the benefit of U.S. patent application Ser. No. 62/901,446, filed Sep. 17, 2019 and incorporated herein by reference.

### BACKGROUND

Unconventional reservoir rocks are known to have thinly layered structures, often with strongly contrasting properties between layers that have disparate thicknesses. This layered nature and contrasting properties can have significant impact on the propagation and height growth of hydraulic fractures. In order to account for this impact in hydraulic fracture modeling, the properties of the layers needs to be measured at a sufficiently high resolution in order to represent the rock layering and the changing properties between layers. For an explanation of one approach to this analysis can be found in U.S. Pat. No. 10,310,136, titled “Lateral placement and completion design for improved well performance in unconventional reservoirs,” which is incorporated by reference herein for all purposes.

The use of high-resolution data in modeling can be challenging due to the amount of data required, both in the acquisition of the data and in the computation time required to run simulations on high resolution data. These challenges are particularly present when attempting to simulate hydraulic fracturing of multiple wells in regional-scale models that aim to represent variability of rock properties in a three-dimensional space.

### BRIEF DESCRIPTION OF THE DRAWINGS

For a more detailed description of the embodiments of the disclosure, reference will now be made to the accompanying drawings, wherein:

FIG. 1 illustrates one embodiment of the current invention.

### DETAILED DESCRIPTION

It is to be understood that the following disclosure describes several exemplary embodiments for implementing different features, structures, or functions of the invention. Exemplary embodiments of components, arrangements, and configurations are described below to simplify the disclosure; however, these exemplary embodiments are provided merely as examples and are not intended to limit the scope of the invention. Additionally, the disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Finally, the exemplary embodiments presented below may be combined in any combination of ways, i.e., any element from one exemplary embodiment may be used in any other exemplary embodiment, without departing from the scope of the disclosure.

All numerical values in this disclosure may be exact or approximate values unless otherwise specifically stated. Accordingly, various embodiments of the disclosure may deviate from the numbers, values, and ranges disclosed herein without departing from the intended scope. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

In the following discussion and in the claims, the terms “including” and “comprising” are used in an open-ended fashion, and thus should be interpreted to mean “including, but not limited to.” Furthermore, as it is used in the claims or specification, the term “or” is intended to encompass both exclusive and inclusive cases, i.e., “A or B” is intended to be synonymous with “at least one of A and B,” unless otherwise expressly specified herein.

Certain terms are throughout the following description and claims refer to particular components. As one having ordinary skill in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function.

For the purposes of this disclosure, the following terms have the means attributed herein. “Layers” means regions of adjacent rock with contrasting rock properties (hard to soft, high modulus to low modulus, high density to low density, high velocity to low velocity, and others) which reduce the normal fracture growth of a hydraulic fracture as a function of the degree of property contrast. “Interfaces” refers to the contact between adjacent layers. “High-resolution” means mm to cm resolution of data (e.g. a data point every mm or cm). “Regional-scale” means a resolution one or more orders of magnitude greater than high-resolution. “Stratigraphic data” refers to the layered geologic properties at a particular location or vertical column within a formation. “Upscaling” refers to the conversion of high resolution data to a lower resolution.

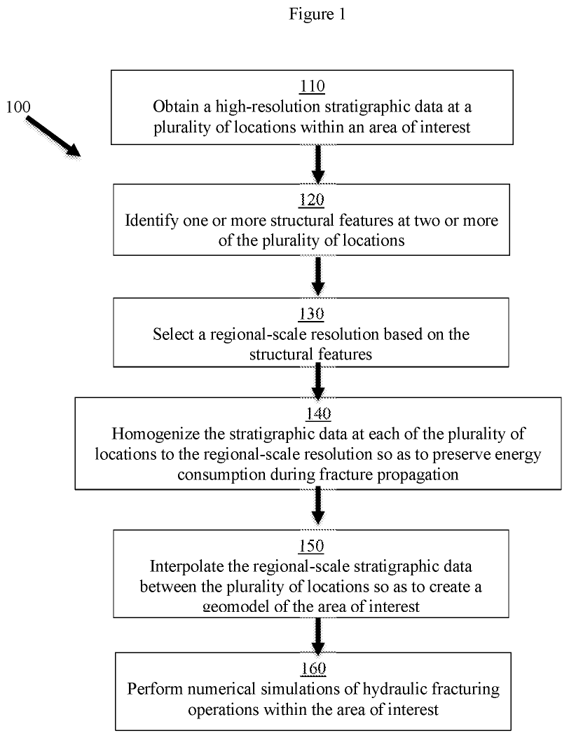

Referring now to FIG. 1, a method for simulating hydraulic fracturing operations 100 includes a first step 110 of obtaining high-resolution stratigraphic data representing a plurality of locations within an area of interest. As will be discussed in detail to follow, the high-resolution stratigraphic data may include properties such as stress, elastic moduli, fracture toughness and leakoff. In a second step 120, the stratigraphic data, along with additional data, can then be analyzed so as to identify one or structural features within the area of interest including formation tops and layers or interfaces that particular impact hydraulic fracturing. Once the structural features are identified, a regional-scaled resolution can be selected based on the locations of the structural features in a third step 130 and then the stratigraphic data from each of the plurality of locations can be homogenized from its native resolution to the regional-scaled resolution in a fourth step 140 that utilizes a technique that preserves the energy consumption during fracture propagation. The homogenized data from each location can then be propagated across the area of interest in a fifth step 150 so as to form a geomodel of the area of interest at the regional-scaled resolution. The geomodel can then be utilized in a sixth step 160 as input data for simulating the hydraulic fracturing of wells within the area of interest.

The above described method allows high-resolution stratigraphic data to be effectively upscaled to a desirable lower-scaled resolution while preserving the small-scale property variations that impact hydraulic fracture propagation. This procedure differs substantially from a standard methodology of resampling (e.g., using well-known techniques) and where the high-frequency variations existing in the original data are smeared such that their effect on physical processes (e.g. hydraulic fracture propagation), is lost. This method allows the use of high-resolution input data for hydraulic fracturing models (i.e., stress, elastic moduli, fracture toughness and leakoff) while preserving the energy consumption requirements during fracture propagation, such that in relation to fracture geometry and fracture properties (e.g., width, length, height, volume, surface area, propped surface area, others) the results are similar or minimally altered compared to the same solution when using the original high-resolution data. Thus, the method allows efficient numerical simulations and modeling of processes including hydraulic fracture propagation coupled to reservoir production modeling, the coupled effect of hydraulic fracture propagation and production, and the various interactions between fracture propagation and reservoir pressure (e.g., poro-elastic effects, induced stresses or stress shadow, induced pore pressure, pressure responses during fracture hits and the overlapping of fractures, and others).

Acquiring High-Resolution Stratigraphic Data

Once an area of interest is identified, stratigraphic data from surrounding wells can be identified. This stratigraphic data may include data acquired through logging, from core samples, or by other means. Data from the area of interest may also include log seismic surveys, micro-seismic data, tilt meters, and other geologic data. In certain embodiments, high-resolution stratigraphic data is gathered using high-resolution core-logger measurements along the length of a core sample (mm-resolution CT, cm-resolution density, anisotropic acoustic velocity, resistivity, elemental composition, hardness, and others). These measurements are used to define the high-resolution mechanical stratigraphy of the core, including thin-layering, changes in properties between layers, and their associated interfaces. Similar high-resolution data may also be gathered through petrophysical logs, borehole image logs, and/or formation micro-imager (FMI) logs that generate high-resolution data that can be used in combination with, or independently from, high-resolution core measurements to define the high-resolution mechanical stratigraphy of the core.

In certain embodiments, samples may be selected from a core at specific depths to measure required rock properties at locations that are representative of the thin layers and the interfaces between thin layers in the formation. These sample locations may be identified in the core by other measurements and/or by high resolution geological core analysis. For example, rock anisotropic elastic properties of Young's modulus, Poisson's ratio and rock fracturing properties of tensile strength and fracture toughness can be measured in the laboratory, using selected samples representative of the heterogeneity of the cored well.

Various known rock classification algorithms and statistical methods can be employed to use multiple inputs of field logs data to define rock groups with similar petrophysical behavior, and by inference similar rock properties. If core or core data is not available, petrophysical logs can be used to conduct Heterogeneous Rock Analysis (HRA) to identify all the dominant rock types present in the system and using the a database for the region of interest, identify the corresponding rock properties for the same HRA classes, which were defined for other projects in the same region.

Lab results of depth-specific rock properties can also be propagated along a section of interest using multi-linear regression algorithms. Statistical methods may also be used to integrate laboratory measured data and high-resolution core logger or image log data to generate high-resolution continuous profiles of all stratigraphic data that are needed as input parameters for hydraulic fracturing, including properties that define reservoir quality. Other data analytics methods can be used to conduct quality control analysis of the high resolution stratigraphic data by comparing the continuous predictions with the depth specific measurements, by conducting statistical analysis of consistency within rock of the same class, and by comparisons with other projects with adjacent wells in the same formations.

Determining Structural Features

The high-resolution stratigraphic data (core, with borehole image logs, and with both) can then be analyzed to determine what structures may be common to each location in the area of interest or may have particular impact on the subsequent well design. These structures can be features such as layers and interfaces having particularly high, or low, strength, conductivity, or permeability characteristics, formation tops, faults, or other features that will have a material impact on hydraulic fracturing. In certain embodiments, these structures may designated or drawn from sources other than the high-resolution stratigraphic data.

Determine Regional-Scale Resolution

Once the critical structures in the area of interest are defined, a regional-scaled resolution can be selected so that the critical structures are captured. In other words, a regional-scaled resolution is selected such that the same number of the homogenized (upscaled) elements for each set of stratigraphic data is the same and that the overall resolution, and resulting mesh, conforms to the geologic structure of the zone of interest.

Homogenize to Regional-Scale Resolution

Data homogenization is used to convert data from disparate sources having different resolutions to the same resolution and there are many known mathematical techniques for effectuating this conversion. For the purposes of the present disclosure, the homogenization is preferably performed in a manner such that energy requirements for fracture propagation are essentially the same for the high-resolution data as compared to the regional-scaled, homogenized data.

The preferred homogenization methods may rely on evaluating the energy requirement for fracture propagation through each rock layer, and each contact between rock layers (or other interfaces in the system), as represented by the high-resolution data. The energy requirements may be considered as a function of fracture toughness, Young's modulus, and Poisson's ration. In certain embodiments, each of fracture toughness, Young's modulus, and Poisson's ration are homogenized separately and then combined to determine a homogenized fracture toughness. The preferred methods then may rely on preserving this energy requirement for rock fracturing by determining the fracture energy or fracture toughness of the rock at the regional-scaled resolution.

Thus, the homogenization methods account for the cumulative energy requirements by a corresponding material fracture toughness, which defines the energy requirement for fracture propagation in a homogeneous medium. In addition, the homogenization methods may account for the resistance introduced by small-scale stress variation that is present in a thinly layered rock so that, for a fracture of the same height, a similar amount of energy is spent for growing the fracture in the homogenized data as the cumulative energy in the thinly layered rock.

Further, in a thinly layered rock, different amounts of fluid are leaked off to the rock layers and to the contacts between rock layers during fracture propagation. This leak-off can be considered a function of the permeability of the rock layer, the hydraulic conductivity of the interfaces, the time associated to fracture propagation, and the fracture propagation pressure. In the regional-scaled, homogenized rock interval, a similar amount of cumulative fluid loss is associated such that when both high-resolution and low-resolution fractures reach the same distance, they both exhibit the same loss of fluid and consequently the same fluid efficiency.

Interpolate Across Area of Interest

Once each stratagraphic data point is homogenized, a geomodel can be constructed by performing interpolation of the regional-scaled stratigraphic data across the zone of interest between data points following the geological structure of the geomodel.

In certain embodiments, multiple realizations of the geomodel can be constructed and statistical analysis performed on the multiple realizations to determine the uncertainty of the properties in the geomodel. This uncertainty analysis can also be used to determine if additional high-resolution stratigraphic data may be desirable.

Perform Simulations

Once the homogenized geomodel is constructed it can be used with a wide variety of simulation packages to perform numerical simulations of hydraulic fracturing and/or reservoir modeling at the selected zone of interest using the homogenized data. Because the homogenized geomodel provides a relatively low resolution geomodel with an accurate representation of the energy consumption during hydraulic fracturing is can be used to conduct large scale multi-pad, multi-well, multi-stage hydraulic fracture simulations in minutes or seconds, and thus allow the time-effective execution of sensitivity studies for optimizing well placement (landing and spacing), near wellbore conditions (tapered perforations, cluster spacing, stage lengths), and fracturing sequencing, with the objective of maximize propped surface area in contact with the hydrocarbon in place to maximize productivity while either maintaining the cost unchanged, minimizing cost, or increasing the production/cost ratio.

While the disclosure is susceptible to various modifications and alternative forms, specific embodiments thereof are shown by way of example in the drawings and description. It should be understood, however, that the drawings and detailed description thereto are not intended to limit the claims to the particular form disclosed, but on the contrary, the intention is to cover all modifications, equivalents, and alternatives falling within the scope of the claims.

What is claimed is:

1. A method for constructing a regional-scale geomodel comprising:
obtaining high-resolution stratigraphic data at a plurality of locations within an area of interest;
identifying one or more structural features at two or more of the plurality of locations;
selecting a regional-scale resolution based on the structural features;
homogenizing the high-resolution stratigraphic data to the regional-scale resolution to generate regional-scale stratigraphic data, wherein the homogenization is performed using a technique that preserves energy consumption during fracture propagation; and
interpolating the regional-scale stratigraphic data between the plurality of locations so as to create a regional-scale geomodel in the area of interest.

2. The method of claim 1 further comprising, performing numerical simulations of hydraulic fracturing using the regional-scale geomodel.

3. The method of claim 1, wherein the high-resolution stratigraphic data is obtained from logs, core samples, or seismic data.

4. The method of claim 1, where in the high-resolution stratigraphic data includes computed tomography, density, velocity, resistivity, composition, or hardness.

5. The method of claim 1, further comprising verifying or supplementing the high-resolution stratigraphic data using data acquired from core samples taken at specific depths.

6. The method of claim 1, wherein the regional-scale resolution is selected such that a resulting mesh conforms to the structural features within the area of interest.

7. The method of claim 1, wherein energy consumption is a function of fracture toughness.

8. The method of claim 7, further comprising determining a homogenized fracture toughness by combining each of fracture toughness, Young's modulus, and Poisson's ratio at that have been homogenized from the high-resolution to the regional-scale resolution.

9. The method of claim 1, wherein the regional-scale stratigraphic data is interpolated along the structure features of the geomodel.

10. A method for constructing a regional-scale geomodel comprising:
obtaining high-resolution stratigraphic data at a plurality of locations within an area of interest, wherein at least a portion of plurality of locations includes a plurality of rock layers and interfaces;
selecting a regional-scale resolution based on one or more structural features at two or more of the plurality of locations;
homogenizing the high-resolution stratigraphic data to the regional-scale resolution to generate regional-scale stratigraphic data, wherein the homogenization is performed using a technique that preserves energy consumption during fracture propagation so that an energy consumption calculated for fracture propagation through the plurality of rock layers and interfaces layers using the high-resolution stratigraphic data is similar to an energy consumption calculated using the regional-scale stratigraphic data; and
interpolating the regional-scale stratigraphic data between the plurality of locations so as to create a regional-scale geomodel in the area of interest.

11. The method of claim 10 further comprising, performing numerical simulations of hydraulic fracturing using the regional-scale geomodel.

12. The method of claim 10, wherein the high-resolution stratigraphic data is obtained from logs, core samples, or seismic data.

13. The method of claim 10, where in the high-resolution stratigraphic data includes computed tomography, density, velocity, resistivity, composition, or hardness.

14. The method of claim 10, further comprising verifying or supplementing the high-resolution stratigraphic data using data acquired from core samples taken at specific depths.

15. The method of claim 10, wherein the regional-scale resolution is selected such that a resulting mesh conforms to the structural features within the area of interest.

16. The method of claim 10, wherein energy consumption is a function of fracture toughness.

17. The method of claim 16, further comprising determining a homogenized fracture toughness by combining each of fracture toughness, Young's modulus, and Poisson's ratio at that have been homogenized from the high-resolution to the regional-scale resolution.

18. The method of claim 10, wherein the regional-scale stratigraphic data is interpolated along the structure features of the geomodel.

19. A method for constructing a regional-scale geomodel comprising:
obtaining high-resolution stratigraphic data at a plurality of locations within an area of interest;
identifying one or more structural features two or more of the plurality of locations;
selecting a regional-scale resolution based on the structural features;
homogenizing the high-resolution stratigraphic data to the regional-scale resolution to generate regional-scale stratigraphic data, wherein the homogenization is performed using a technique that preserves energy consumption during fracture propagation;
interpolating the regional-scale stratigraphic data between the plurality of locations so as to create a regional-scale geomodel in the area of interest; and
performing numerical simulations of hydraulic fracturing using the regional-scale geomodel.

20. The method of claim 19, wherein the numerical simulations of hydraulic fracturing include simulating multi-well, multi-stage hydraulic fracturing operations.
